(19) United States
(12) Patent Application Publication
(10) Pub. No.: US 2006/0113358 A1
(43) Pub. Date: Jun. 1, 2006

(54) Multihead friction welding method and device for carrying out the method

(75) Inventor: Leonhard Crasser, Naila (DE)

Correspondence Address: Stephen M. Evans;GRAYBEAL JACKSON HALEY LLP, Suite 350, 155 - 108th Avenue NE, Bellevue, WA, 98004-5901, US

(73) Assignee: Multi Orbital Systems, GmbH

(21) Appl. No.: 11/335,087

(22) Filed: Jan. 18, 2006

Related U.S. Application Data
(63) Continuation-in-part of application No. PCT/EP04/08050, filed on Jul. 19, 2004.

(30) Foreign Application Priority Data
Jul. 18, 2003 (DE) DE103 32 824.6

(51) Int. Cl. B23K 20/12

(52) U.S. Cl. 228/112.1

(57) ABSTRACT

The invention relates to a multi-head friction welding method and a device for carrying out said method. According to said invention, the axes of the eccentric shafts of moulded pieces, which are oriented to each other and tensioned in relation to each other, can be adjusted in relation to each other with an axial offset from δ=0 to δ=2r, wherein r is the oscillation amplitude, and the phase vectors of both friction welding heads reach a common orbital position at least at the end of the friction welding process. The eccentric shafts of the friction welding heads are braked from a substantially in-phase or anti-phase position at the end of the friction welding process, while maintaining the phase rotation direction, and the phase vectors of both friction welding heads stop in a common position on the orbital curves.

### CROSS-REFERENCE TO PRIORITY APPLICATION

This is a continuation-in-part application that claims benefit, under 35 USC §120, of co-pending International Application PCT/EP2004/008050, filed on 19 Jul. 2004, designating the United States, which claims foreign priority under 35 USC §119 (a) to German Patent Application No. 103 32 824.6 filed 18 Jul. 2003, which applications are incorporated herein by reference.

### BACKGROUND OF INVENTION

The invention concerns a multihead friction welding method for the simultaneous welding of joining surfaces of shaped parts, whereby individual shaped parts are clamped on both sides of and proximal to the said joining surfaces as well as in exact alignment with one another within the influence of friction welding heads, and whereby the joining surfaces are pressed together and the free ends of the said shaped parts on both sides of the joining surfaces, respectively, are set into vibration by means of eccentric shafts, which rotate within the friction welding heads, the said friction welding heads vibrating, essentially in counter phase, in both the X-Z and the Y-Z direction. The invention further concerns a device for the execution of the said method.

Friction welding methods, as such, are well known, whereby, by means of relative movement and simultaneous pressure friction is generated, in order to produce the necessary welding energy at the surfaces to be welded.

### SUMMARY OF INVENTION

The multihead friction welding methods, which were mentioned in the opening passage, are particularly adaptable to linearly symmetric and rotationally symmetric welding and are disclosed by DE 193 8 099 A1 as well as by DE 19 938 100 A1. In these friction welding methods, conventional friction welding generators as disclosed by EP 707 919 A1 are used to create relative movement in the joining plane of the ends of the profile members, which are confronting one another. These friction welding generators are incorporated into friction welding heads, which, respectively, are located on each side of the joining plane between two profile members, which are to be welded to one another. These profile members are affixed in place by clamps, in such a manner, that their joining surfaces butt against each other, precisely aligned. The frictional welding energy is fed to the said end of the profile member by means of a vibration plate, which is rigidly attached to the clamp. As welding takes place, the clamps associated with the joining planes are, under pressure, simultaneously moved against each other.

The vibration generator known from EP 707 919 A1 is equipped with a controlling eccentric and a parallel guide, which convert the rotational energy delivered by a motor to the input side into a circular, parallelly guided, momentum. The ends of the profile members to be welded together are, aligned in an exact relationship to one another, moved out of their start position for the welding by means of the counter phased vibration movements, which is conducted from the vibration plate to the clamps, and are rubbed together for such a period of time, that their joining surfaces are heated to the temperature of welding. Subsequently, the vibration generators, and therewith the clamps, which were set into vibration by the vibration plate energized by a respective vibration generator, are mechanically positively driven back into their start position, whereby the ends of the profile members remain under pressure throughout the period of the welding and the cooling phase.

This driving back into the start position, of the two profile members to be welded together, is effected by the inertia of the spindle and by a detent on the controlling eccentric. From this arises as a disadvantage that, in the case of a substantial thrust force in the welding seam, the cam coacting with the controlling eccentric, as a result of a non-defined reset force, cannot assure a positive reset into the start position (i.e., the zero point). In the case of a very moderate thrust force in the welding seam, it is possible that the cam, after the impact, bounces off into an undefined position.

On this account, it is an object of the invention, to provide a multihead friction welding method and a device, which is adapted for the execution of the said method, wherewith the disadvantages of the known means can be overcome. Simultaneously, a vibration generator of essentially simpler construction and thereby of less expense shall be made available.

As to the multihead friction welding method of the kind discussed in the opening passages, this purpose is achieved by the features of claim 1.

A multihead friction welding device for the execution of the said method is characterized by means of the features of claim 9.

Further embodiments of the invention are subject to the subordinate claims.

The advantages presented by the means of the invention, are essentially that, first, the vibration generator is equipped with only a single eccentric and does not require a complex double eccentric, as is used in the known vibration generator mentioned in the introductory passages. Second, no reset force is necessary upon the ending of the welding phase according to the invention, much more, a secure and definite deceleration to the start position is assured because of the powerful drive motors necessary for the welding, especially in cases of metallic shaped parts, since the full motor power stands available for the decelerating operation and for exceeding the thrust forces in the welding seam as the said seam sets into its final hardness. For this procedure, only a short time is required, lasting from one to only a few tenths of a second. Fundamentally, this yields a considerable advantage, since, for every point in time during the welding and the decelerating, the mass moments are equalized.

### BRIEF DESCRIPTION OF DRAWINGS

The advantages and the features of the invention may be found in the following description of an embodiment example and in combination with the claims and the attached drawing.

There is shown in:

FIG. 1 a top view onto the friction welding unit with two right-angled profile members to be welded;

FIG. 2 a profile view of the friction welding unit looking in the direction north to south of FIG. 1;

FIG. 3A-3D a diagrammatic view of the axis offset of the vibration axes of the two vibrating generators of a friction welding head in the joining plane for a direct phased and a counter phased vibration with different axis offsets;

FIG. 4A an example of different phase positions of the friction vibration effective in the joining plane for an axis offset in accord with FIG. 3A with a direct phased friction vibration;

FIG. 4B a diagram of the thrust components for a friction vibration in accord with FIG. 4A;

FIG. 5A an example of different phase positions of the friction vibration effective in the joining plane for an axis offset in accord with FIG. 3C with a counter phased friction vibration;

FIG. 5B a diagram of the thrust components for a friction vibration in accord with FIG. 5A;

FIGS. 6A-6D further embodiments of the invention; and

FIG. 7 a top view on a multihead friction welding device for the welding of a right angled profile framing.

### DETAILED DESCRIPTION OF DRAWINGS

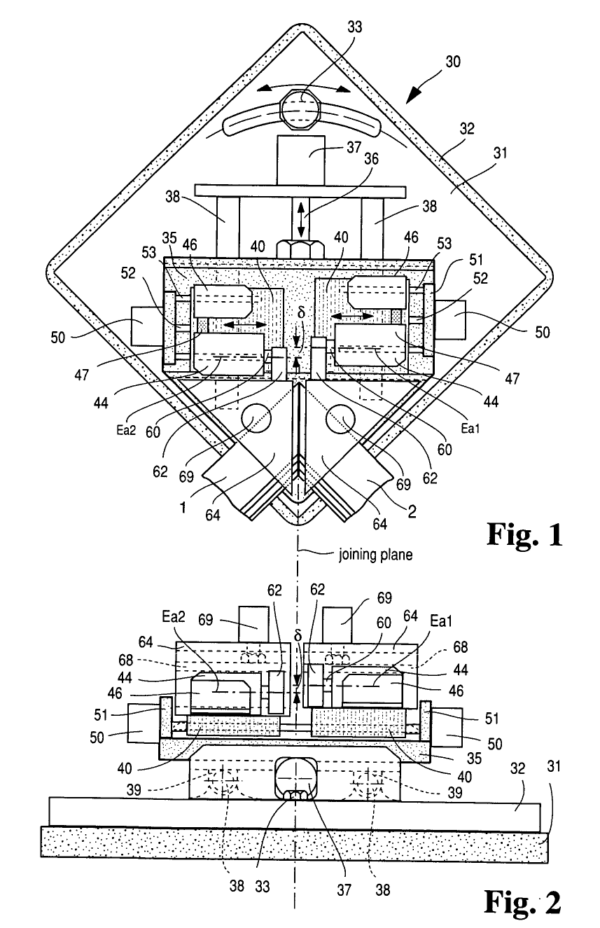

In FIG. 1 is presented a friction welding unit 30 with two friction welding heads 44, which are used in the welding of two profile members 1 and 2, the ends of which having a miter angle of 45°. For this purpose, the friction welding heads 44, respectively, are each provided with a clamping unit 64, in which the respective end of the profile member is clamped so that, by means of the vibration plate 62, which is connected to the clamping unit, the vibration energy can be introduced into the ends of the profile members. For that operation, the friction welding heads 44 are so controlled, that the opposed free ends of the profile members vibrate in an essentially counter phase manner, that is to say, that the thrust vectors are counter directed at each point in time.

As parameters for the friction welding process, four values exist, namely, the frequency and the amplitude of the vibration, the pressure and the closing speed, respectively, and the time, during which the two joining surfaces are be pressed against one another.

With regard to the frequency, provision is made for the circular vibration to be introduced into the profile members, that it falls between 20 Hz and 500 Hz, with consideration given to the materials of the profile member, whereby the vibration has a maximum amplitude of, preferably, less than 3 mm. For the solidification of the welding, that is, in the case of plastics, when the working temperature for machining is reached, a time interval of less than 30 seconds is to be expected. Within these values, considerable differences can be attributed to the chosen materials, especially here for the structural members 1 and 2. In the use of thermoplastic materials such as PVC, with a modulus of elasticity of about 2800 Nm at room temperature, one can expect that, at a vibration frequency of about 120 Hz and an amplitude of about 0.6 mm, the welding process can be shut down after a few seconds, already. These conditions also act very favorably, where noise avoidance is necessary.

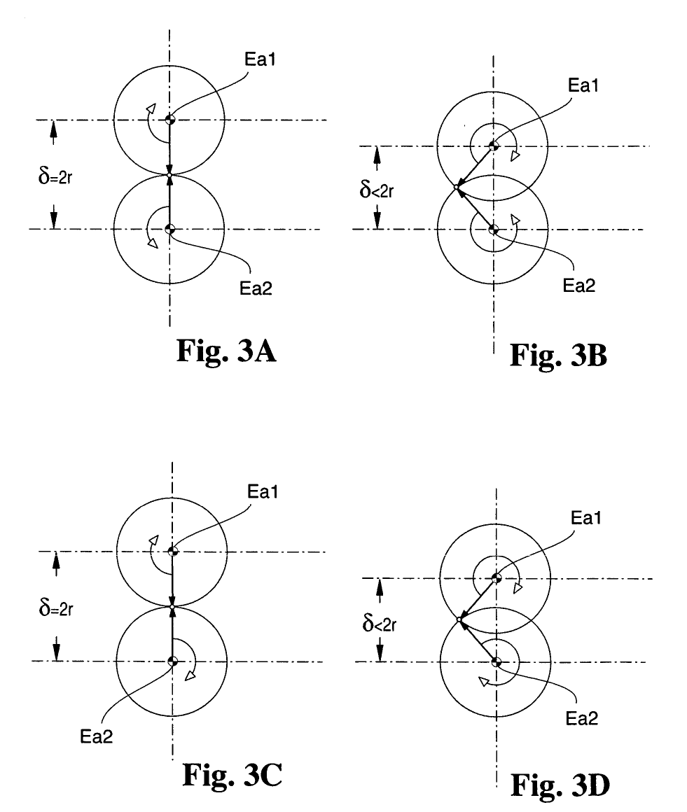

A friction welding unit 30, which is constructed pivotally with reference to a base plate 31 on the pivoting plate 32, can be fixed at a given point in a pivotally changeable position with the aid of a fixation knob 33. On the said pivoting plate 32 is fastened a mounting plate 35, which can be moved back and forth in a north/south direction as per FIG. 1 with the help of an axle cylinder 37 and a thrust shaft 36 assigned thereto, which engages with the mounting plate, along the guide shafts 38 in the ball bushing guide 39 (FIG. 2).

Also, on the mounting plate 35 are sliders 40 slidable on structural rail guides in an east/west direction as per FIG. 1. This sliding is done with the aid of axle cylinders 50, which are mounted to the mounting wall 51 on both sides of the mounting plate 35. The guide shafts 53, which are affixed for guidance on the mounting wall 51, serve the purpose of assuring a tip-over free sliding of the slider 40. Of course, other optional slide apparatuses could be seen as being appropriate.

The vibration energy necessary for friction welding is transmitted from the friction welding heads 44, through an eccentric shaft 60 and a vibration plate 62, to the clamps 64. These clamps have, in the top view, the shape of a right triangle and, in the profile view, would possess a U-shaped reception portion (not shown), the base of which runs perpendicularly to the joining plane. The, in the top view, upper and lower leg of the said U-shaped reception portion, extend over the total width of the profile members to be worked on, and are fixed in place with the aid of a clamping plate 68. This clamping plate 68 is vertically forced against the inserted profile member by means of the profile tightening cylinder 69. The friction welding heads 44, which are located on the respective slider 40, are, other than those in the vibration generator taught by EP 707 919, only equipped with single eccentric shafts 60 and, with the aid of an electronic control, easily synchronized, particularly to the start and the end position, as will be shown later. Thereby, assurance is provided, that the friction welding method starts with the desired phase shift and this phase shift is continually maintained. That is to say, the phase setting between the individual friction welding heads 44 is securely held.

As may be inferred from FIG. 1 and FIG. 2, the friction welding heads 44 are so mounted on the slider 40 that an axis offset δ can be adjusted between the two eccentric shafts Ea1 and Ea2, which lie opposite one another. In the presentation in accord with FIG. 1, is to be seen a horizontal axis offset δ and in FIG. 2 a vertical axis offset δ is provided. Obviously, an axial offset in any optional angular direction is possible. The usage of a vertical or a horizontal axis offset for two different embodiments produces substantially the same result, and is chosen in accordance with the kind of the form of the to be welded shaped parts. For the axis offset, it is possible that a rigid mounting of at least one friction welding head can be provided on the slider 40. It is, however, also possible to provide a controlled slidability of the friction welding head on both sliders 40.

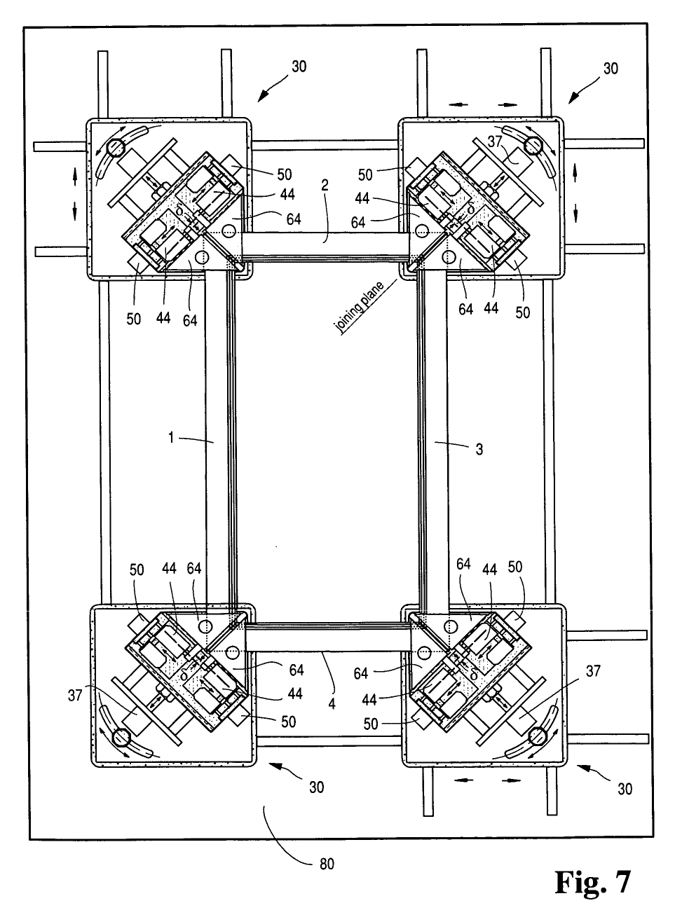

The above described friction welding units 30 can also, as presented in FIG. 7, find application in the known friction welding device for the welding of a right angled, rectangular profile frame, in order that the four corners of a right angled, rectangular profile frame with the members 1, 2, 3 and 4 can be simultaneously welded. With the presented friction welding device, it is also possible that rectangular profile frames having corner joints, which deviate from 90° can be welded. When this is done, during the procedure of the friction welding, the amplitude, axis offset and the phase setting of the friction welding heads at each of the four corners of the framing must be so tuned together in pairwise fashion that the introduced forces and torques from all the friction welding heads are compensating as the welding is carried out.

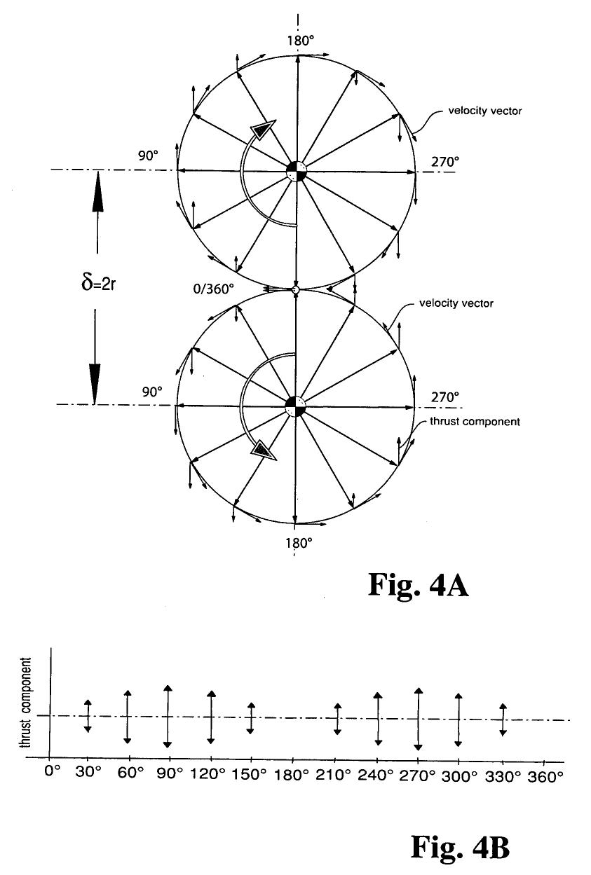

In FIGS. 3A to 3D is shown, in a schematic representation, the axis offset δ of to the axes Ea1 and Ea2 of the eccentric shafts of the friction welding heads 44 for an orbital vibration with circular path curves with, as shown in the drawing, synchronously and reversely running phase vectors.

Fundamentally, for an optimal friction between the joining surfaces, a phase offset of 180° at path points coinciding with one another is to be expected. In the case of such a phase offset, a maximum energy input occurs. Naturally, a less than 180° phase offset can be provided, if a reduced energy input is desired.

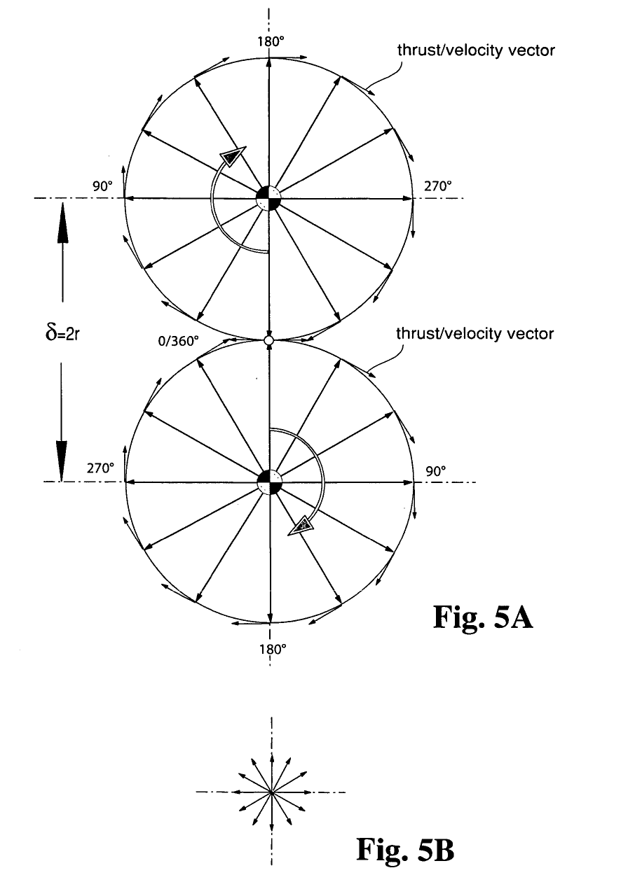

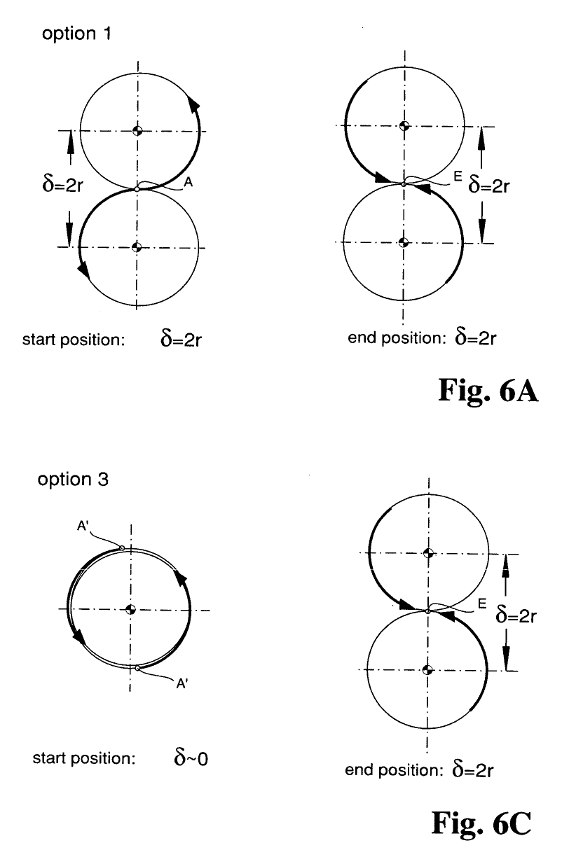

The execution of a friction welding process is described, referring to FIGS. 4A and 4B, for an equally phased circulating friction vibration, that is, a linear effective thrust/velocity vector, and, with the aid of FIGS. 5A and 5B, a description is provided for a counter phased circulating friction vibration, that is, an orbitally effective thrust/velocity vector, whereby the phase difference stands at 180°. In the presentation the encircling friction vibrations, that is, the kinematic conditions in the joining plane, are to be seen in an axial view from one side.

For the friction welding process, firstly, the friction welding heads 44 are brought to the zero position, in which the phase vectors are directed toward the two mutually associated track curves which intersect at the starting position A of the eccentric shafts. In this position, the shaped parts 1 and 2 are affixed in the clamps 64, whereby the joining surfaces stand confronting one another with the most possible exactness.

Out of this zero position, the axially offset eccentric shafts are so set into rotation, that the phase vectors of the FIGS. 4A and 4B move out of the zero position in counter phase. In the Figures, the positions of the phase vectors, respectively, are shown following a rotation of about 30°. Analogously, the same is valid for FIGS. 5A and 5B. In each position the velocity vector is noted. A superimposition of the velocity vectors of the friction vibration of the two oppositely directed friction welding heads leads to a thrust component, which, in a linear parallel position, changes in amplitude and results in a linear friction movement, which, at 0° and 180° tends to zero. Analogously, this is also valid for counter phased friction vibrations, where, in each position of the phase vectors, counter directed velocity vectors result and thus thrust vectors, which circulate orbitally, that is, orbitally revolving friction movements are created.

Because of the axis offset δ of an exactly double vibration amplitude, the track curves meet once per each 360°-rotation of the eccentric shafts and, after that, move away from each other, once again. On this account, the result is that the joining surfaces, which find themselves exactly coincident in the zero position, do not frictionally rub together at the edge positions during the entire friction welding process.

In practice, it turns out that the friction welding connection, in the case of a temporary failure of coincidence in the edge zones, does not suffer, since at the commonly used small welding amplitudes, these being less than 1 mm, sufficient energy is still introduced into the edge zones, so that even these are heated up to a plastic state. The welding deposit, which emerges due to the heating under the joining pressure, assures, because of the bulge being generated, a satisfactory, break-resistant welding of the entire joining surface.

The faultless, break-resistant welding is also assured, in that the eccentric shafts in the stopping phase, are synchronously decelerated without a change of the phase position, and are brought to a stillstand in the zero position of the friction welding heads, that is, in the start position A. During this deceleration, the phase position is retained without change.

Because of the fact that the strong driving load, which is necessary for the friction welding, is also available for the deceleration, a safe restoration to the zero point, that is, an end position, which is identical to the start position, is assured.

The continual rotation during the welding phase and halting in a defined position of the eccentric shafts, and indeed, in this common end position E of the track curves, is carried out with the aid of electronic control so that, at the end of the decelerating operation, i.e. more or less during the last rotation, when the movement is practically decelerated down to zero, stillstand assuredly occurs exactly in the starting position A. For this purpose, during the welding and the deceleration phase, the phase position is continually read out and the decelerating is controlled at least during the last rotation until stoppage.

In this arrangement, the further advantage can be found that, with a decrease of the frequency of rotation, because of the powerful drive motors, a higher torque can be applied in order to compensate for the increasing thrust torques developing in the seam during shut off. Since the powerful drive motors serve simultaneously as brake motors, a correspondingly great braking force stands available for the deceleration phase, as already mentioned.

By means of this controlled deceleration to the stillstand, no material homogeneities come about in the melting zone, which are inevitable with an abrupt interruption of the introduced vibration energy, when using the said conventional and known vibration generator as a result of the undefined reset into the zero position and the bouncing off of the spindle.

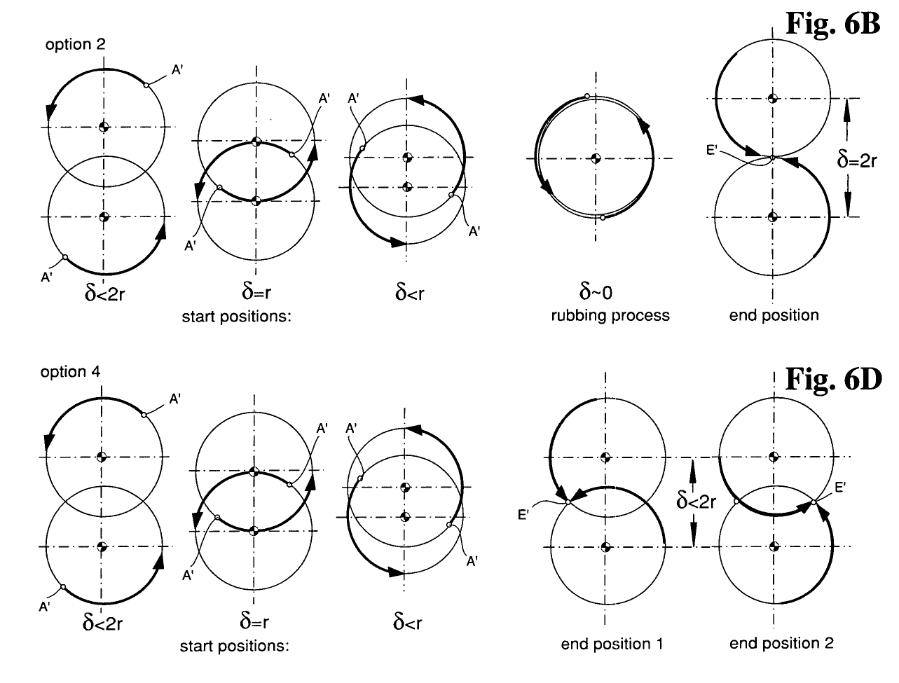

In FIG. 6 a further embodiment of the invention is shown in a diagrammatic manner. In this embodiment, the axis offset δ is not held constant during the friction welding method, but varies after the start of the friction welding method from an axis offset δ=2r, whereby r is equal to the vibration amplitude, particularly varies to an axis offset of preferably δ<r. Thereby, assurance is given, that the failure of coincidence in the edge zones is minimized to a very short time interval during the entire friction welding process.

As may be inferred from the presentation of FIG. 6, the change of the axis offset during the friction welding process brings about a more or less complete coincidence of the friction surfaces. In order that the friction welding process is decelerated to a complete stillstand, the deceleration must stop at an axis offset of δ=2r at the end of the friction welding process, which is the end position E or, conversely, at the end position E′ the axis offset must be δ<2r, whereupon the track curves would respectively intersect.

By means of this controlled displacement of the axis offset, the phase shift of the coacting friction vibrations is retained.

By means of this controllability of the axis offset, there arises principally four essential possibilities of the friction welding process:
1) At δ=2r and with a constant axis offset as well as a constant phase shift of 180°, the start position A is identical to the end position E (see FIG. 6A, option 1);
2) In a case of a variable axis offset, that is, δ as well as start position A′ and end position E′ are variable, then the axis offset, after the start of the friction welding process, is set to δ˜0 at a constant phase shift of 180° and, prior to the end of the friction welding process, the axis offset is set to δ=2r. The friction welding process is then decelerated to the end position E′ (see FIG. 6B, option 2);
3) The friction welding process starts with an axis offset of δ˜0 and a constant phase shift of 180° in the start position A′. Prior to the end of the friction welding process, the axis offset is set to δ=2r and the process decelerated to the end position E (see FIG. 6C, option 3);
4) The friction welding process starts with a variable axis offset 6 in an optional start position A′ of the phase vectors, however, with a constant phase shift of, for example, 180°. Towards the end of the friction welding process, that is, up to the decelerated stillstand of a phase vector in one of the end positions E′ defined by intersection points of the two track curves, the constant phase shift is retained. After that, the second phase vector is followed-up by being decelerated to a stillstand in the same end position. Because of the two intersection points of the track curves, two possible end positions result, i.e. end position 1 and 2 (see FIG. 6D, option 4).

For the cooperatively guided relative movements of the joining surfaces necessary during the welding phase, advantageously, a distance/time control is applied, which greatly simplifies the design of the electronic control in combination with the phase control during the welding and decelerating operations. The invention, thus, offers not only the advantage of the simplified construction of the vibration generators because of the axis offset δ, but also a more simplified design of the open and closed loop control apparatus during the welding and braking phases.

What is claimed:

1. A multihead friction welding method for the simultaneous welding of joining surfaces of shaped parts, whereby the individual shaped parts are clamped on both sides of and proximal to the said joining surfaces as well as in exact alignment with one another within the influence of friction welding heads, and whereby the joining surfaces are pressed together and the free ends of the said shaped parts on both sides of the joining surfaces, respectively, are set into vibration by means of eccentric shafts, which rotate within the friction welding heads, and whereby both friction welding vectors of the free ends of the shaped parts and the said friction welding heads, respectively, vibrate, essentially in equal phase or in counter phase, in both the X-Z and the Y-Z direction,
characterized in that
the friction welding process runs with a constant phase shift of ≦180°;
the axis position of the eccentric shafts of the friction welding heads at the beginning of the friction welding process is adjusted to a predetermined start position between an axis coincidence (δ=0) up to a separating distance having a value of two vibration amplitudes (δ=2r); and
the friction welding process starts with an axis offset of Ø≦δ≦2r and ends with an axis offset of δ≦2r, whereby the eccentric shafts, at the end of the friction welding phase, are controllingly decelerated in such a manner that the circulating phase vectors of the vibrations of the two friction welding heads come to a stillstand in a common end position.

2. A multihead friction welding method in accord with claim 1,
characterized in that
the said axis offset during the entire friction welding process is adjusted to δ=2r, so that the friction welding vectors start out from the common start position and, at the end of the friction welding process, coincide again in the same position.

3. A multihead friction welding method in accord with claim 1,
characterized in that
the axis offset δ, for the entire friction welding process, is be variably altered at a constant phase shift, whereby the axis offset, after the start of the friction welding process, is set to δ˜0 for the active friction period and, at the end of the friction welding process, is adjusted by control to the axis offset δ=2r.

4. A multihead friction welding method in accord with claim 1,
characterized in that
the friction welding process starts with an axis offset of δ˜0 and a constant phase shift and, only prior to the end of the friction welding process, is adjusted to an axis offset of δ=2r.

5. A multihead friction welding method in accord with claim 1,
characterized in that
the friction welding process starts with an axis offset of 2≦δ˜Øand this axis offset, during the entire friction welding process, is retained unchanged;
the constant phase shift is retained up to the end of the friction welding procedure, that is, up to the decelerated stillstand of one phase vector in an intersection of the two track curves, which designates the end position E′; and
the second phase vector is subsequently followed-up by being decelerated to a stillstand at the same end position.

6. A multihead friction welding method in accord with claim 1,
characterized in that
the vibration amplitude is adjusted to be of a value between 0.1 mm and the width or the length of the joining surface, respectively, preferably to approximately 3 mm.

7. A multihead friction welding method in accord with claim 1,
characterized in that
the said multihead friction welding method is used for the welding of door and window framings of plastic or of metal profile members.

8. A multihead friction welding method in accord with claim 1,
characterized in that
the vibration frequency of the friction welding head is adjusted to a value between 15 Hz and 500 Hz at an amplitude of <5 mm, and the shaped parts are rubbed together for less than 40 seconds with the vibration frequency.

9. A multihead friction welding device with several, preferably four friction welding units, which are placed on an adjustable machine bed for the welding of the joining surfaces of open or closed shaped part framings, for the carrying out of the method in accord with one of the claims 1 to 4, whereby each friction welding unit consists of two friction welding heads, the vibration plates of which are respectively rigidly attached to clamping means, in each of which clamping means a free end of a shaped part can be clamped, whereby, further, the two friction welding heads assigned to a joining plane, including their clamping means, are mounted on a mounting plate in such a manner that they can be moved against one another so that they can be adjusted with respect to the joining plane,
characterized in that
the friction welding heads can be so positioned with axis offsets, that the axes of the eccentric shafts can be displaceably adjusted from an axis coincidence (δ=0) up to twice the vibration amplitude (δ=2r) and the track curves of the phase vectors meet in a common position on their track curves, at least in the end position at a stillstand.

10. A multihead friction welding device in accord with claim 9,
characterized in that
the axis offset (δ) is adjusted to be between about 0.1 mm and one of the width or the length of the joining surface, respectively.

11. A multihead friction welding device in accord with claim 9,
characterized in that
the device is used for the welding of the joining surfaces of open or closed shaped part framings, whereby each joining surface is assigned to a friction welding unit.
